(19) United States
(12) Patent Application Publication
(10) Pub. No.: US 2006/0214909 A1
(43) Pub. Date: Sep. 28, 2006

(54) Vertical cavity surface-emitting laser in non-hermetic transistor outline package

(76) Inventors: Ju Chin Poh, Penang (MY); Sundar N. Yoganandan, Gelugor (MY); Sh Hua Chong, Singapore (SG); Hajarah Bee Bt Haji Mohideen, Penang (MY)

Correspondence Address: AVAGO TECHNOLOGIES, LTD., P.O. BOX 1920, DENVER, CO, 80201-1920, US

(21) Appl. No.: 11/088,111

(22) Filed: Mar. 23, 2005

(51) Int. Cl. G09G 5/00

(52) U.S. Cl. 345/156

(57) ABSTRACT

A device includes a header, a cap having an unsealed aperture attached to the header, and a laser device disposed on the header configured so as to emit through the unsealed aperture. A passivation layer at least partially encapsulates the VCSEL chip.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

A computer pointing device generally moves a cursor on a display screen of a computer system relative to where the user moves the pointing device. One type of computer pointing device is commonly referred to a computer “mouse.” Some computer mice use a rubberized ball and multiple rotary pulse generators to track the direction of a computer mouse as it is moved across a surface. Movement across a suitable surface causes the rubberized ball to roll within the housing of the computer mouse. However, the rubberized ball does not reliably roll across some types of surfaces, and can pick up dirt or lint that interferes with the operation of the computer mouse.

Another type of computer mouse uses a light-emitting diode (“LED”) to illuminate the surface the computer mouse is moved across (the “working surface”), and uses an optical detector to track the movement of the computer mouse. This type of computer mouse is commonly referred to as an “optical mouse.”

Optical mice avoid the problem of unreliable rolling and do not pick up dirt and lint, like a computer mouse with a rubberized ball. However, LED optical mice do not reliably track their motion across certain types of surfaces, such as glossy paper, some painted surfaces, a shiny desk top, or white tile board. A laser-based optical mouse is available that has improved performance, compared to an LED-based optical mouse, on glossy surfaces; however, noise signals are sometimes generated that create tracking errors. A particular type of noise is called fixed-pattern noise.

Fixed-pattern noise signals are stationary artifacts in the field of view and can originate from many sources, such as dust particles on the laser source or imaging sensor. Various techniques are used to mitigate the effects of fixed-pattern noise. Navigation algorithms are used to detect mouse movement in the presence of fixed-pattern noise; however, this consumes systems resources and can cause failure in cases where too great a proportion of the imaging sensor does not evolve with mouse movement. Thus, it is desirable to provide techniques for more reliable optical tracking on a wide selection of surfaces that avoid the issues arising in the prior art,

### BRIEF SUMMARY OF THE INVENTION

A device includes a header, a cap having an unsealed aperture attached to the header, and a laser device disposed on the header configured so as to emit a single mode coherent light beam through the unsealed aperture. A passivation layer at least partially encapsulates the VCSEL chip.

### BRIEF DESCRIPTION OF THE DRAWINGS

FIG. 1A shows a cross section of a laser device according to an embodiment of the invention.

FIG. 1B shows a plan view of a portion of the laser device of FIG. 1A.

FIG. 1C is an isometric view of the laser device of FIG. 1A.

FIG. 2A is a cross section of a computer pointing device according to an embodiment of the invention.

FIG. 2B is a cross section of a computer pointing device according to another embodiment of the invention.

### DETAILED DESCRIPTION OF THE EMBODIMENTS

A conventional laser device used in optical telecommunication applications uses a VCSEL chip in a TO package having a cap with a glass window covering an opening in the top of the cap. The glass window hermetically seals the TO package while providing a transmission path for the coherent light beam from the VCSEL chip to the outside of the package.

However, the glass windows used to seal TO packages often have imperfections, such as small particles in the glass, that create diffraction patterns in the light beam. The diffraction patterns can cause noise in the imaged beam that interferes with tracking accuracy (mouse navigation). Thus, such a packaged laser device is unsuitable for use in computer tracking applications. The diffraction patterns caused by particles in the path of the laser beam appear as diffractive rings that are similar to the waves generated when a pebble is tossed into calm water.

The glass window in conventional laser devices provides a hermetically sealed package for the VCSEL chip and prevents moisture from entering the hermetic package, which could otherwise result in oxidation of the VCSEL chip and an early failure. The package is usually sealed in a nitrogen atmosphere, which purges oxygen from the interior of the package before it is sealed. A VCSEL in a TO package with a glass window is suitable for transmitting data, such as fast ETHERNET and fiber channel applications, but the diffraction arising from non-uniformities in the glass window interferes with using such devices in computer mouse applications.

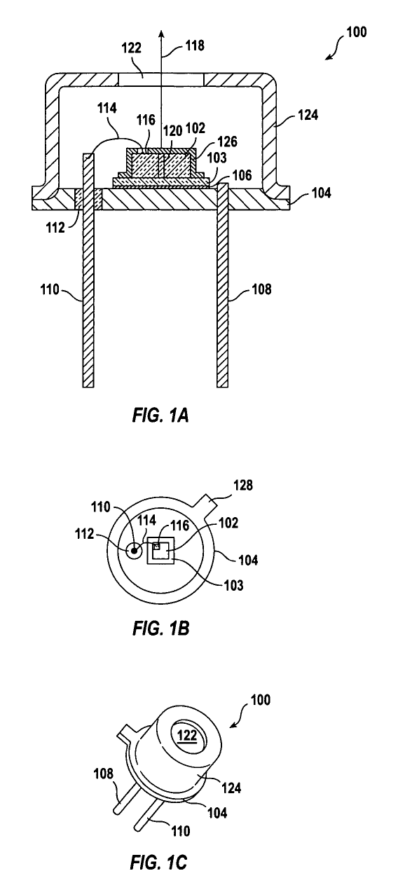

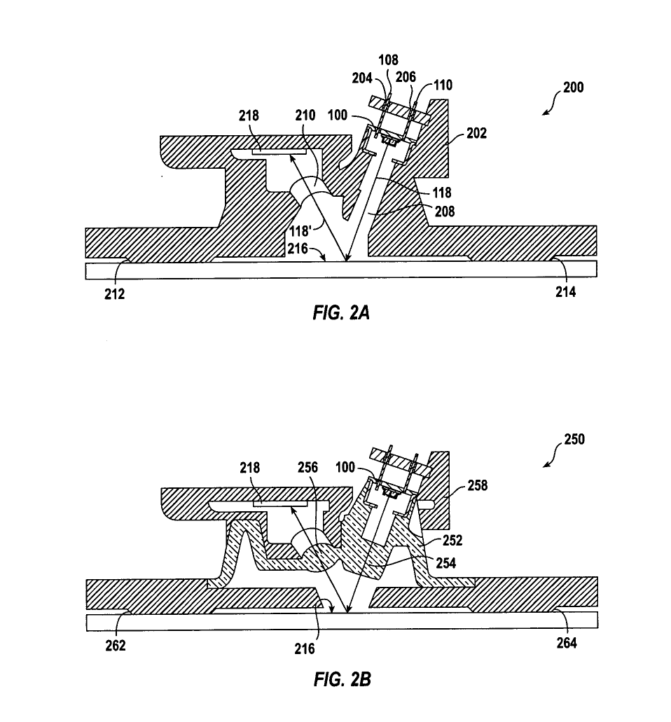

FIG. 1A shows a cross section of a laser device 100, such as vertical cavity surface-emitting laser (“VCSEL”) device, according to an embodiment of the invention. A laser chip, such as a single-mode VCSEL chip (also commonly called a “die”) 102 is attached to a substrate 103, which in turn is attached to a header 104 of a transistor outline (“TO”) package using conventional die attach techniques. Alternatively, the VCSEL is a multi-mode VCSEL used with an imaging sensor (see FIG. 2, ref. num. 218) that can differentiate the desired signal(s) from the undesired signal(s) to sense movement of a computer mouse. In a particular embodiment, the substrate 103 is piece (“chip”) of doped semiconductor (e.g. silicon). A metal layer 106 on the underside of the substrate 103 provides a first contact (e.g. an N-contact) between the header 104 and the laser chip 102. In a particular embodiment, the substrate 103 is electrically and mechanically coupled to the header 104 using silver epoxy. Alternatively, a laser chip has first and second contacts elsewhere, such as on the top surface of the laser chip.

A first lead 108 is electrically coupled to the metal layer 106 of the substrate 104. A second lead 110 is electrically isolated from the header 104 by a non-conductive feed-through 112. A bond wire 114 couples the second lead 110 to a second contact pad 116 of the laser chip 102. The first lead 108 and second lead 110, and their associated electrical paths, allow electrical power to be provided to the laser chip. When proper electrical power is provided to the laser chip, a single mode coherent light beam, represented by an arrow 118, is emitted from an active gain region 120. The coherent light 118 passes through an unsealed aperture 122 in a cap 124 of the laser device 100. The unsealed aperture provides a path through free space (e.g. air) from the interior of the package to the exterior of the package. Thus, the package does not contribute to noise of the coherent light beam from the laser chip, but also does not provide a hermetic seal.

A passivation layer 126 partially encapsulates the laser chip 102. The passivation layer 126 is not drawn to scale, and is shown as being much thicker than it actually is for purposes of illustration. In one embodiment, the laser chip is surrounded by the passivation layer except for the contact pad 116 and the backside of the laser chip 102 that is attached to the substrate 103. The passivation layer 126 partially surrounds the laser chip 102 and covers a portion of the substrate 103, leaving the metal layer 106 on the backside of the substrate 103 uncoated for electrical connection to the header. The passivation layer 126 in combination with the substrate, which protects the backside of the laser chip, provides a hermetic barrier to protect the laser chip without placing a diffraction (noise) causing interface in the package of the laser device.

In a particular embodiment, the passivation layer 126 is a transparent layer of silicon nitride. The coherent single-mode light 118 emitted by the active gain region 120 is transmitted into free space through the passivation layer 126 and continues in free space through the unsealed aperture 122 to a destination outside of the package, such as a target surface, an optical imaging element, or dust barrier (see generally, FIGS. 2A, 2B).

In comparison to a glass window, the passivation layer 126 is very thin, and is also made from very pure components in a highly controlled deposition system. The passivation layer 126 provides a very uniform film without the embedded particles found in glass windows of conventional TO packages. A packaged laser device according to FIG. 1A provides a coherent light beam with significantly less noise than a conventionally packaged VCSEL using a glass window having a diffraction-causing imperfection.

The cap 124 is metal and is sealed to the header 104 using a projection welding process. Other cap materials and attachment techniques are used in alternative embodiments, and the cap may be shapes other than cylindrical. The cap 124 protects the laser chip 102 and bond wire 114 from mechanical damage during shipping and handling.

A small piece of polyimide tape with silicone adhesive, such as KAPTON® tape, from DuPont of Wilmington, Del., is used to cover the unsealed aperture 122 during shipping and handling to prevent foreign objects, such as dust particles, from entering the package. A dust particle on the emitting area of the laser die can cause diffraction patterns, and thus a noisy output, similar to the imperfections in conventional glass window-type TO packages. A dust particle can also block the laser beam (partially or fully), which will block the light source for system navigation. It is preferable that the laser die is fabricated and packaged in a relatively dust-free environment (“clean room”). The tape or other temporary barrier, in combination with the TO cap, provides a temporary dust barrier to protect the laser die from contamination until the tape is removed and the packaged laser device is assembled into the end-part (e.g. mouse body). Assembly of the packaged laser device into the end-part is also preferably done in a clean room.

Using a cap 124 with an unsealed aperture 122, as opposed to using a glass window, provides many advantages. First, the path from the laser die to the target (i.e. the working surface, not shown) provides a path for the coherent light beam 118 that is not degraded by a glass window that has an air interface on both sides, and typically has particles within the glass that create optical signal noise. Second, using a partially encapsulated VCSEL allows attaching the cap 124 to the header 104 in an air environment, rather than in a nitrogen or other non-air environment, which simplifies manufacturability. Omitting the glass window also eliminates the glass-to-metal seal between the window and the cap, which can fail and allow moisture leakage through the glass-to-metal seal to the VCSEL. The passivation layer 126 hermetically seals the laser chip 102, thus a hermetic sealed package is not necessary. Encapsulated VCSELs according to an embodiment passed a 1,000 hour reliability test of 85% humidity at 85° C.

FIG. 1B shows a plan view of a portion of the laser device of FIG. 1A. The laser chip 102 is mounted on the substrate 103, which is mounted on the header 104. The second lead 110 extends through the non-conductive feed-through 112. The bond wire 114 connects the second contact pad 116 of the laser chip 102 to the second lead 110. The header 104 includes an alignment tab 128 that indicates which lead (not shown) is connected to the header. The alignment tab 128 assists in assembling TO-packaged devices in circuits, such as when the polarity of the leads is important for proper device operation.

FIG. 1C is an isometric view of the laser device 100 of FIG. 1A. The leads 108, 110 are part of the header 104, which is welded to the cap 124. The header 104 and cap 124 form a TO package with an unsealed aperture 122 that provides a free-space path from the partially encapsulated VCSEL (see FIG. 1A, ref. Num. 102, 126) to outside of the TO package.

FIG. 2A is a cross section of a computer pointing device 200 according to an embodiment of the invention. A packaged laser device 100 is mounted in a body 202 of the computer pointing device 200. The body 202 is typically molded from plastic and is shown as a single piece for purposes of convenient illustration. The leads 108, 110 are inserted into sockets 204, 206 that electrically connect the laser device 100 to the computer pointing device 200. The body 202 of the computer pointing device has pads 212, 214 that allow the computer pointing device 200 to slide across a working surface 216.

The working surface 216 is a glossy surface, or alternatively is a non-glossy surface of the type used with conventional optical computer pointing devices. Pathways 208, 210 in the housing 202 provide paths through free space for the coherent light beam 118 from the laser device 100 to the working surface 216, and for a reflected coherent light beam 118′ from the working surface 216 to an imaging sensor 218. The imaging sensor is a laser mouse sensor, such as the laser mouse sensor available from AGILENT TECHNOLOGIES, INC., as used in the laser mouse LOGITECH Model No. MX1000™.

The coherent light beam 118 shines on the working surface 216 and the imaging sensor 218 captures images from the working surface 216 to track the movement of the computer pointing device 200 across the working surface. A laser-based computer mouse is able to work on more surfaces than a conventional LED-based optical computer mouse. A laser-based computer mouse is able to reliably track movement across white tile board, glossy paper and painted surfaces. A LED-based optical computer mouse usually does not reliably operate on these types of surfaces. In a particular embodiment using a VCSEL device according to FIG. 1A, a laser-based optical computer mouse had up to a 20-times improvement in surface tracking accuracy compared to a conventional LED-based optical computer mouse, based on the type of surface being tracked. Generally, the greatest improvement in surface tracking accuracy occurs for smooth, glossy surfaces, such white tile board and painted metal. Significant improvements are also seen on other types of surfaces, such as varnished or painted wood surfaces, black photocopies, black FORMICA, magazine cover surfaces, and photographic paper. Other laser devices are used in alternative computer pointing devices according to embodiments of the invention.

Using a VCSEL chip with a passivation layer in a non-hermetic package in a computer pointing device provides reliable operation partly because of the environment that computer pointing devices are typically used in, and also because the laser device is generally pointing downwards, toward a working surface. A computer pointing device is usually used in a closed, relatively dry indoor environment. The laser chip in the computer pointing device is not subjected to the environmental conditions that a laser chip in an open, telecommunications application is often exposed to. Hermetically sealing the laser chip with a thin, uniform passivation layer avoids degradation of the laser chip from moisture and does not degrade the optical quality of the laser beam, as transmitting the laser beam through a glass window of a conventional TO package can do.

FIG. 2B is a cross section of a computer pointing device 250 according to another embodiment of the invention. A packaged laser device 100 is mounted in a transparent body 252 of the computer pointing device 200. The transparent body 252 is molded from transparent optical plastic and includes a collimation portion 254 and an imaging lens portion 256 and is shown as a single piece for purposes of convenient illustration. The transparent body 252 is supported by an outer body 258 that is similar to the body 202 of FIG. 2A. Mounting the packaged laser device 250 in the transparent body 252 provides a dust-free operating environment for the laser die, with only the single perimeter seal of the TO can to the transparent body. Using a cylindrical TO can is particularly desirable because it is easy to form the corresponding socket in the transparent body, and the packaged laser device is easily aligned along their common axis. The cylindrical contact area also provides an extensive, secure seal.

Imperfections in the transparent body 252 can cause imperfections in the coherent light beam that result in noise; however, this problem is mitigated. First, the transparent body is made from a high-purity optical polymer that does not include the types of stones and impurities found in the glass used in conventional window-type TO packages. Second, the transparent body 252 is tested to insure the absence of imperfections that would produce excessive noise. In comparison, imperfections in the glass window of a conventional packaged laser device are not found until the die is attached, wire bonded, and the TO can is sealed. If the packaged laser device fails testing, the rejected part has a relatively large amount of assembly time and components that are wasted, compared to the transparent body 252.

The transparent body not only provides optical functions, but also serves as a dust barrier for both the laser die and the imaging sensor 218. The outer body 258 includes pads 262, 264 that allow the computer pointing device 250 to slide across a working surface 216. In an alternative embodiment, the packaged laser device 250 is mounted in an outer body. In a further embodiment, the transparent body having collimating and imaging lens portions is omitted, and a non-optical transparent dust barrier(s) is provided to keep dust from settling on the laser die and/or imaging sensor. It is generally desirable that a dust barrier be configured to allow dust removal and/or suppression techniques. Dust on the emitting surface of the laser die or on the imaging sensor can cause diffraction, and hence noise that might interfere with the tracking accuracy of the computer pointing device.

While the preferred embodiments of the present invention have been illustrated in detail, it should be apparent that modifications and adaptations to these embodiments might occur to one skilled in the art without departing from the scope of the present invention as set forth in the following claims. In particular, while embodiments utilizing VCSEL devices have been discussed, other embodiments use alternative laser devices.

What is claimed is:

1. A laser device comprising:
a header;
a cap having an unsealed aperture attached to the header;
a first lead;
a second lead;
a laser chip electrically coupled to the first lead and to the second lead and configured so as to emit a coherent light beam through the unsealed aperture; and
a passivation layer at least partially encapsulating the VCSEL chip.

2. The device of claim 1 wherein the laser chip is a single-mode vertical cavity surface-emitting laser (“VCSEL”) chip

3. The device of claim 1 further comprising a substrate disposed between the header and the laser chip, wherein the passivation layer covers a portion of the substrate.

4. The device of claim 3 further comprising a metal layer on the substrate proximate to the header.

5. The device of claim 1 wherein the passivation layer comprises silicon nitride.

6. The device of claim 1 wherein the coherent light beam is transmitted though the passivation layer.

7. The device of claim 1 wherein the header is a transistor outline (“TO”) package header and the cap is a TO package cap.

8. The device of claim 7 wherein the cap is cylindrical metal cap.

9. A computer pointing device comprising a laser device in accordance with claim 1.

10. The computer pointing device of claim 9 further comprising:
a laser mouse imaging sensor;
a first pathway providing a first free-space path from the laser chip to a working surface.

11. The computer pointing device of claim 10 further comprising:
a second pathway providing a second free-space path from the working surface to the laser mouse imaging sensor.

12. The computer pointing device of claim 9 further comprising:
a laser mouse imaging sensor; and
a transparent body disposed between the laser chip and a working surface.

13. The computer pointing device of claim 12 wherein the transparent body includes a collimation portion disposed between the laser device and the working surface.

14. The computer pointing device of claim 12 wherein the transparent body includes an imaging lens portion disposed between the working surface and the laser mouse imaging sensor.

15. The computer pointing device of claim 12 wherein the laser device is mounted in the transparent body.

16. The computer pointing device of claim 12 wherein the cap of the laser device is cylindrical.
